(19) United States
(12) Patent Application Publication
(10) Pub. No.: US 2012/0278320 A1
(43) Pub. Date: Nov. 1, 2012

(54) RECOMMENDATION INFORMATION PROVIDING SYSTEM, RECOMMENDATION INFORMATION PROVIDING APPARATUS, RECOMMENDATION INFORMATION SERVICE METHOD, AND RECOMMENDATION INFORMATION DISTRIBUTION PROGRAM

(76) Inventor: Shoji Ogura, Tokyo (JP)

(21) Appl. No.: 13/321,906

(22) PCT Filed: May 25, 2010
(86) PCT No.: PCT/JP2010/058778

§ 371 Date: Jan. 31, 2012

(30) Foreign Application Priority Data
Jun. 2, 2009 (JP) 2009-133036

(51) Int. Cl. G06F 17/30

(52) U.S. Cl. 707/736; 707/E17.044; 707/E17.032

(57) ABSTRACT

A recommendation information providing apparatus includes: a stay record managing section configured to store a stay record as a record when each of a plurality of users stayed in each of a plurality of locations; and a visit pattern calculating section configured to calculate a first visit pattern showing statistic data of the stay records for each of the plurality of locations. A candidate location extracting section extracts a second visit pattern to a specified location related to recommendation information from a plurality of the first visit patterns, extracts a third visit pattern which meets a determination value met by the second visit pattern from the plurality of first visit patterns, and extracts a similar location having the third visit pattern from the plurality of locations. A recommendation level calculating section extracts from the stay records, a first user and a second user of the plurality of users who stayed in at least one of the specified location and the similar location, calculates a fourth visit pattern of the first user to the specified location and the similar location from ones of the stay records related to the first user, calculates a fifth visit pattern of the second user to the specified location and the similar location from ones of the stay records related to the second user, and calculates a first priority level of the specified location and the similar location to be notified to the first user and a second priority level of the specified location and the similar location to be notified to the second user based on the fourth visit pattern and the fifth visit pattern.

### TECHNICAL FIELD

The present invention is related to a recommendation information providing system, a recommendation information providing apparatus, a recommendation information service method and a recommendation information service program, which are based on records of locations where a user of a terminal equipment visited.

### BACKGROUND ART

In recent years, an information provider becomes able to provide a lot of amount of information to a consumer with digitization of the information and network communication represented by WWW (World Wide Web). However, the information provided by the information provider is not all of the information requested by the consumer and is only a part of it. Therefore, a technique is requested that the information requested by the consumer can be provided efficiently from the information provider. In such a situation, the information provider provides a search engine for a Web page from which information is acquired based on an input from the user of the terminal equipment, as information providing service through the network. Also, the information provider provides an information recommendation engine for providing information useful to the user based on purchasing and browsing records of the user, even if there is no specified input from the user of the terminal equipment. The information recommendation engine can select and provide the information without any specified input of the user. Therefore, there is an advantage that the user can save an input time and information of a field which the user did not know can be acquired. However, the existing information recommendation engine can only carry out the provision of the information of recommended articles based on the purchasing and browsing records and the information of the recommended music based on listening records. Thus, an information range which can be provided by the existing information recommendation engine is limited to the articles and the service introduced on the Web site.

On the other hand, the user of a GPS terminal equipment can measure his position easily through general spread of the GPS terminal equipment such as a car navigation system and a mobile phone which can use GPS (Global Positioning System). It is thought, that the action pattern and choice of the user are reflected on the position data. The information provider is trying to carry out an information provision service which the user needs, based on the position data. A technique of the information provision service based on the position data is disclosed in from Patent Literature 1 to Patent Literature 3.

The information providing system according to Patent Literature 1 is provided with a movement history managing section which manages a first movement history of a first user as an object of an information provision service and second movement histories of other users, a similarity determining section which determines a similarity between the first user and each of the other users based on the first movement history and the second movement histories, and an information determining section which determines information to be provided to the first user based on the second movement history of the other user who is similar to the first user and a current position of the first user. In such an information providing system, it becomes possible to carry out the information providing service corresponding sufficiently to the interest and nature of each of the users which receives service actually, and the provision of the information which fits with the individual can be realized in a low cost.

A method of providing information described in Patent Literature 2 is provided with a step of receiving the position data acquired and accumulated by a first information terminal, which is portable and is carried by a user, a step of receiving data of information contents, a step to determining a relation of the position data and the data of the information contents, and a step of providing information to the user based on the determination result. Such a method of providing information becomes able to provide only the information related to the user by filtering based on the living area of the user such as an action area of the user, from a great deal of information.

Also, a technique is disclosed in Patent Literature 3, in which information suitable for a current situation of each user is provided by using a network. This information providing system is provided with an action history data collecting section, an action history data storage section, a request information providing section, a provision information storage section, an action predicting section, and an additional information providing section. The action history data collecting section sequentially collects an actual action record of each user as a part of the action history data showing a peculiar action pattern and stores it in the action history storage section as past action history data. The request information providing section extracts provision information according to a request from storage data in the provision information storage section according to the request from a specific user, and provides to a handheld terminal equipment of the user through the Internet. When the provision information is provided for the user, the action predicting section refers to the action history data in the action history data storage section, and predicts an action after the action related to the provision information as a predicted action. The additional information providing section extracts the provision information related to the predicted action from the provision information storage section and provides it for the handheld terminal equipment of the user. Such an information providing system allows accurate information provision to be carried out under the consideration of a daily action pattern every user.

### Citation List:

[Patent Literature 1]: JP 2002-140362A

[Patent Literature 2]: JP 2003-308329A

[Patent Literature 3]: JP 2008-123317A

### SUMMARY OF THE INVENTION

Because the action pattern and choice of the user are reflected on the position data (records of the current position and the past position), it is extremely effective to select the information to be provided for the user based on the position data. However, when information in an optional category recommended by the information provider exists, there is a fear that the information provided for the user is limited to the information in the category even if the provision information is based on the position data of the user. Also, even if the information which reflects the choice of the user is searched based on the position data and an input of user himself, there is a fear that the acquired information is limited to information in the category specified by the user. Therefore, a service is demanded which can provide the information which reflects the action pattern and choice of the user accurately without being limited to a category recommended by the information provider and the category specified by the user, in other words, which can provide expected information which reflects the action pattern and the choice of the user although the information provider and the user himself do not notice.

One of the subject matters of the present invention is to provide a recommendation information providing system which can provide a user with unexpected information which reflects an action pattern and a choice of the user, regardless of a specified input of the user.

The recommendation information providing apparatus of the present invention includes: a stay record managing section configured to store a stay record as a record when each of a plurality of users stayed in each of a plurality of locations; a visit pattern calculating section configured to calculate a first visit pattern showing statistic data of said stay records for each of said plurality of locations; a candidate location extracting section configured to extraction a second visit pattern to a specified location related to recommendation information from a plurality of said first visit patterns, extraction a third visit pattern which meets a determination value met by said second visit pattern from said plurality of first visit patterns, and extraction a similar location having said third visit pattern from said plurality of locations; and a recommendation level calculating section configured to extraction from said stay records, a first user and a second user of said plurality of users who stayed in at least one of said specified location and said similar location, calculate a fourth visit pattern of said first user to said specified location and said similar location from ones of said stay records related to said first user, calculate a fifth visit pattern of said second user to said specified location and said similar location from ones of said stay records related to said second user, and calculate a first priority level of said specified location and said similar location to be notified to said first user and a second priority level of said specified location and said similar location to be notified to said second user based on said fourth visit pattern and said fifth visit pattern.

The recommendation information providing method includes: storing a stay record as a record when each of a plurality of users in each of a plurality of locations; calculating a first visit pattern showing statistic data of said stay records for each of said plurality of locations; extracting a second visit pattern to a specified location related to recommendation information from a plurality of said first visit patterns; extracting a third visit pattern which meets a determination value met by said second visit pattern, from said plurality of first visit patterns; extracting a similar location having said third visit pattern from said plurality of locations; extracting a first user and a second user of said plurality of users who stayed in at least one of said specified location and said similar location from said stay records; calculating a fourth visit pattern of said first user to said specified location and said similar location from ones of said stay records related to said first user; calculating a fifth visit pattern of said second user to said specified location and said similar location from ones of said stay records related to said second user; calculating a first priority level of said specified location and said similar location to be notified to said first user based on said fourth visit pattern and said fifth visit pattern; and calculating a second priority level of said specified location and said similar location to be notified to said second user based on said fourth visit pattern and said fifth visit pattern.

The recommendation information providing system of the present invention can be provided for the user, the unexpected information which reflects the action pattern and choice of the user regardless of the specified input of the user.

### BRIEF DESCRIPTION OF THE DRAWINGS

The subject matters, effect, and features of the present invention cooperate would become clearer from the description of exemplary embodiments in conjunction with the following drawings:

FIG. 1 is a block diagram showing a configuration example of a recommendation information providing system 1 according to a first exemplary embodiment of the present invention;

FIG. 2 is a configuration example of a position data table;

FIG. 3 is a configuration example of a data table;

FIG. 4 is a configuration example of a stay record table;

FIG. 5 is a configuration example of a statistic data table;

FIG. 6 is an example of a matrix in which a plurality of candidate locations, a plurality of users who stayed in the plurality of candidate locations, and the number of times of stay by each of the plurality of users in each of the plurality of the candidate locations;

FIG. 7 is a diagram showing a correlation coefficient R of the user having “u0001” and each of other users;

FIG. 8 is a diagram showing an example of a score calculated every candidate location for each of the other users other than the user having “u0001”;

FIG. 9 is a diagram showing a score of the user having “u0001” every candidate location;

FIG. 10 is a diagram showing scores calculated to all the users every candidate location;

FIG. 11 is a block diagram showing a hardware configuration example of a terminal equipment 10 and a recommendation information providing apparatus 20 in a recommendation information providing system 1 according to an exemplary embodiment;

FIG. 12 is a flow chart showing a processing operation to store a stay record (a visit record) in the recommendation information providing system 1 according to a first exemplary embodiment of the present invention;

FIG. 13 is a flow chart showing a processing operation of providing information which reflects an action pattern and choice of the user, in the recommendation information providing system 1 according to the first exemplary embodiment of the present invention;

FIG. 14 is a configuration example of the statistic data table in a second exemplary embodiment of the present invention;

FIG. 15 is a flow chart showing a processing operation of providing information which reflects the action pattern and choice of the user in the recommendation information providing system 1 according to the second exemplary embodiment of the present invention;

FIG. 16 is an example of a matrix in which a plurality of candidate locations, all users who stayed in the plurality of candidate locations, the number of times of stay by each user in each of the plurality of candidate locations; and

FIG. 17 is a flow chart showing a processing operation of providing information which reflects the action pattern and choice of the user in the recommendation information providing system 1 according to a third exemplary embodiment of the present invention.

### DESCRIPTION OF EXEMPLARY EMBODIMENTS

Hereinafter, a recommendation information providing system according to the present invention will be described with reference to the attached drawings.

### First Exemplary Embodiment

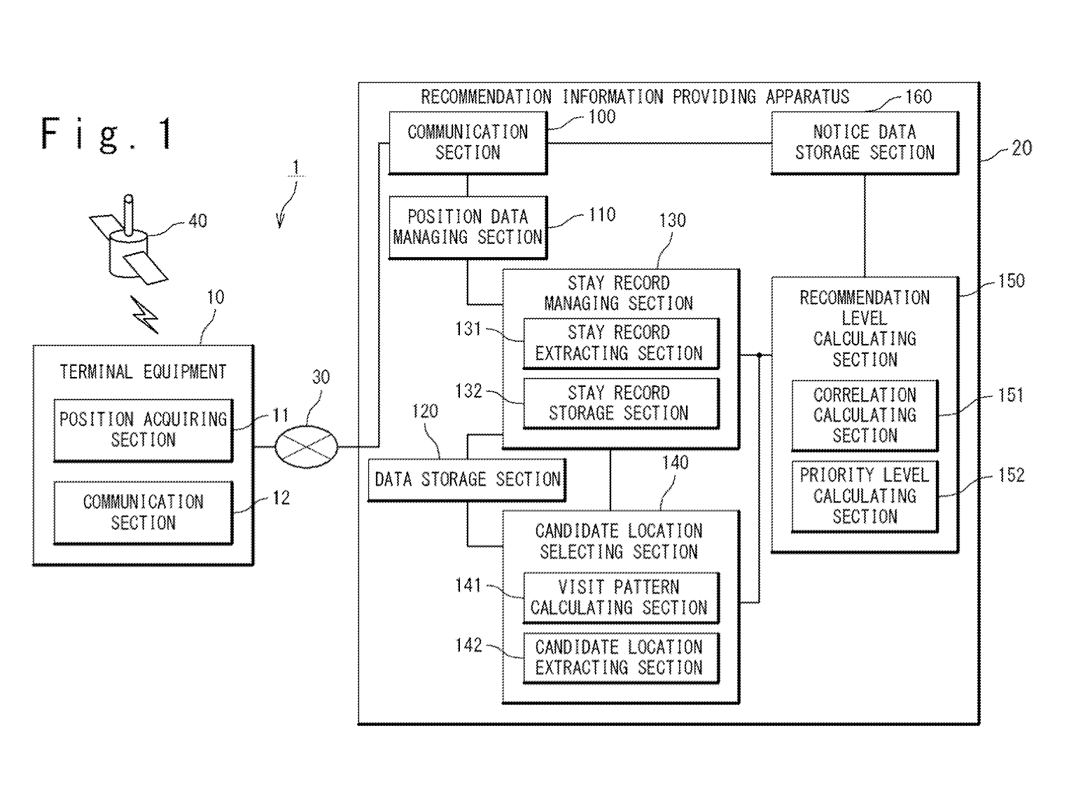

The first exemplary embodiment of the present invention will be described. FIG. 1 is a block diagram showing a configuration example of the recommendation information providing system 1 according to the first exemplary embodiment of the present invention. Referring to FIG. 1, the recommendation information providing system 1 is provided with a terminal equipment 10 and a recommendation information providing apparatus 20. The terminal equipment 10 and the recommendation information providing apparatus 20 are connected through a network 30. It should be noted that a plurality of terminal equipments 10 may be contained.

The terminal equipment 10 is an equipment, which is operated by a user and is communicable, such as a portable phone and a mobile game machine. The terminal equipment 10 can receive position data from a GPS (Global Positioning System) satellite 40 and transmits it to the recommendation information providing apparatus 20 as the position data of the user. The terminal equipment 10 contains a position acquiring section 11 and a communication section 12.

The position acquiring section 11 receives the position data periodically from the GPS satellite 40. The position acquiring section 11 supplies the received position data to the communication section 12. The position data received from the GPS satellite 40 includes data of latitude and longitude. In the present exemplary embodiment, a case where the terminal equipment 10 acquires the position data from the GPS satellite 40 will be described. However, the position data may be acquired by using radio communication such as RFID (Radio Frequency Identification) and WiFi, as well as the GPS satellite 40.

The communication section 12 acquires the position data from the position acquiring section 11. The communication section 12 gives a measurement time to the acquired position data and retains it. It should be noted that the measurement time may be a measurement time at which the position data is received from the GPS satellite 40. The communication section 12 relates the position data, the measurement time at which the position data has been acquired and a user ID for identifying a user, and transmits them to the recommendation information providing apparatus 20 through the network 30. Hereinafter, the position data of the user (the position data of the terminal equipment 10), the measurement time at which the position data has been acquired, and the user ID are referred as terminal data. The timing which the communication section 12 transmits the terminal data may be immediately after the position data has been acquired from the position acquiring section 11 or after a preset optional time period. When the communication section 12 transmits the terminal data after the optional time period, the terminal data may contain a plurality of position data and a plurality of measurement times.

The recommendation information providing apparatus 20 receives the terminal data from the plurality of terminal equipments 10. The recommendation information providing apparatus 20 calculates a location reflecting an action pattern and choice of the user of each of the terminal equipments 10, and data on the location based on the terminal data, and transmits to each of the terminal equipments 10. Each terminal equipment 10 receives data suitable for the action pattern and choice of the user from the recommendation information providing apparatus 20 without needing any explicit input by the user, and can provide the data for the user. The recommendation information providing apparatus 20 is provided with a communication section 100; a position data managing section 110; an data storage section 120; a stay record managing section 130; a candidate location selecting section 140; a recommendation level calculating section 150; and a notice data storage section 160.

The communication section 100 receives the terminal data from the plurality of terminal equipments 10 through the network 30. The communication section 100 provides the terminal data for the position data managing section 110. Also, the communication section 100 acquires a location which reflects the action pattern and choice of the user of each of the plurality of terminal equipments 10 and data on the location from the notice data storage section 160, and transmits them to a corresponding one of the terminal equipments 10.

When acquiring the terminal data from the communication section 100, the position data managing section 110 relates an ID used to identify the terminal data and a time at which the terminal data is recorded and stores in a position data table.

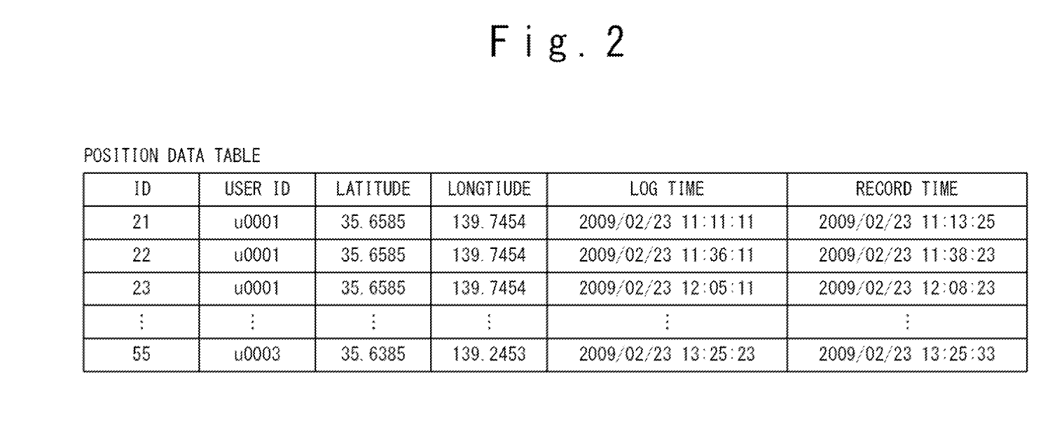

FIG. 2 is a configuration example of the position data table. Referring to FIG. 2, the position data table contains “ID” used to identify the terminal data; “user ID” used to identify the user of the terminal equipment 10; “latitude” indicative of latitude; “longitude” indicative of longitude; “log time” indicative of a measurement time; and “record time” indicative of a time at which the position data managing section 110 has stored the terminal data. It should be noted that “user ID”, “latitude”, “longitude” and “log time” are contained in the terminal data transmitted from the terminal equipment 10.

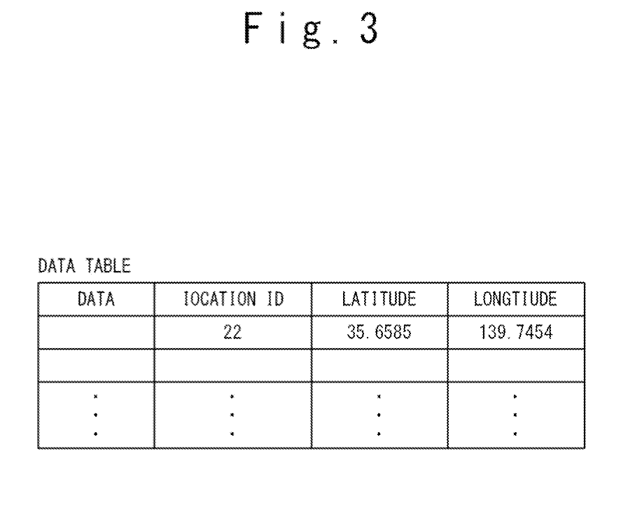

The data storage section 120 stores a data table. FIG. 3 shows a configuration example of the data table. Referring to FIG. 3, the data table contains “data” indicative of a category and the contents of data to be provided; “longitude” indicative of longitude; “latitude” indicative of latitude; and “location ID” used to identify the longitude and the latitude

The stay record managing section 130 refers to the position data table to determine a stay of each of a plurality of users, and manages stay records (visit records) as records indicating a plurality of locations in which the plurality of users have stayed or visited. The stay record managing section 130 contains a stay record extracting section 131 and a stay record storage section 132.

The stay record extracting section 131 refers to the position data table to determine whether each of the plurality of users has stayed in a specific area for a specific time. When determining that a specific user of the plurality of users has stayed, the stay record extracting section 131 extracts the plurality of locations in which the specific user has stayed and a stay time for each of the plurality of locations, and stores in the stay record storage section 132.

A method of determining the stay of the user by the stay record extracting section 131 will be described. The stay record extracting section 131 refers to the position data table each time the position data managing section 110 stores the terminal data in the position data table or periodically at predetermined time of every day, for example, at 1 o'clock. The stay record extracting section 131 determines whether or not a user having an optional “user ID” has stayed, from the position data table based on a retained stay condition. The stay condition which the stay record extracting section 131 retains contains a threshold value of a stay time and a threshold value of an area of a stay location, and is used to determine whether the user is in the area of the location during a predetermined time period. For example, the stay condition is “a stay time is equal to or more than 30 minutes and an area of a stay location is within 100 meters”. When determining that the user has stayed, based on the stay condition, the stay record extracting section 131 supplies the “user ID” of the user; the latitude “latitude”; the longitude “longitude”; and the measurement time “log time” to the stay record storage section 132.

In detailed, the stay record extracting section 131 refers to the position data table of FIG. 2 to extract “u0001” in the field of “user ID”. The stay record extracting section 131 extracts all of the position data in the fields of “latitude” and “longitude” and the measurement time in the field of “log time” which are related to “u0001”, and determines whether or not the user has stayed based on the stay condition. Here, the stay record extracting section 131 determines that records “21”, “22” and “23” in the field of “ID” which are related to “u0001” indicate the stay, and supplies to the stay record storage section 132, “u0001” in the field of “user ID”; “35.6585” in the field of “latitude”; “139.7454” in the field of “longitude”; and “2009/02/23 12:05:11”, “2009/02/23 11:36:11”, and “2009/02/23 11:11:11” in the field of “log time”.

The stay record storage section 132 stores data of a plurality of users, a plurality of locations where each of the plurality of users has stayed, and stay times, which are all acquired from the stay record extracting section 131, in a stay record table as stay records (visit records).

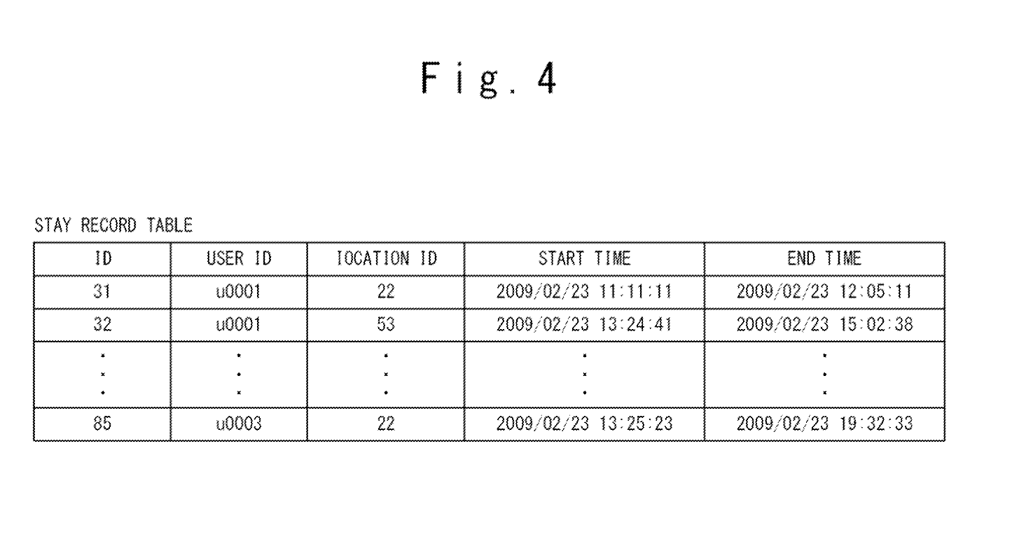

FIG. 4 is a configuration example of the stay record table. Referring to FIG. 4, the stay record table contains “ID” for identifying the stay record, “user ID” for identifying the user of the terminal equipment 10; “location ID” for identifying a stay location, “start time” showing a start time of the stay; and “end time” showing an end time of the stay. Thus, the stay time is shown as a time period from the stay start time and the stay end time. When acquiring user ID in the field of “user ID”; longitude in the field of “longitude”; latitude in the field of “latitude”; and measurement time in the field of “log time” from the stay record extracting section 131, the stay record storage section 132 gives an “ID” for identifying a stay record and stores a stay record. Then, the stay record storage section 132 acquires “location ID” from a data table of the data storage section 120 based on “latitude” and “longitude” indicating the latitude and the longitude in the position data table relates and stores it. Moreover, the stay record storage section 132 stores “start time” and “end time” of the stay time based on the measurement times “log time”.

In detail, when acquiring “u0001” as “user ID”, “35.6585” as “latitude”, “139.7454” as “longitude”, “2009/02/23 11:11:11”, “2009/02/23 11:36:11” and “2009/02/23 12:05:11” as “log time” from the position data table shown in FIG. 2, the stay record storage section 132 gives “31” as “ID”. The stay record storage section 132 extracts “22” as “location ID” from the data table based on “35.6585” as “latitude” and “139.7453” as “longitude”, and stores in the stay record table. Moreover, the stay record storage section 132 stores “start time” and “end time” for the stay time based on “2009/02/23 11:11:11”, “2009/02/23 11:36:11” and “2009/02/23 12:05:11” as measurement times in the field of “log time”.

It should be noted that when “location ID” corresponding to “latitude” and “longitude” is not contained in the data table, the stay record storage section 132 gives “location ID” of the location which is the nearest to “latitude” and “longitude” in the stay record in which “location ID” is not present. Or, the stay record storage section 132 regards as one new stay location, a location in the neighborhood of locations in a plurality of stay records in which “location ID” is not present. For example, the stay record storage section 132 gives a new “location ID” as the stay location, a location within 300 meters from locations in the plurality of stay records in which “location ID” is not contained, and stores in the stay record table.

The candidate location selecting section 140 select a plurality of candidate locations to recommend to each of the plurality of users. The candidate location selecting section 140 contains a visit pattern calculating section 141 and a candidate location extracting section 142.

The visit pattern calculating section 141 refers to the stay record table in the stay record storage section 132, and calculates a visit pattern for each of all locations (all “location ID”) and stores the visit patterns for all the locations in the statistic data table. The visit pattern shows statistic data of the stay records every location. The timing when visit pattern calculating section 141 calculates the visit pattern is timing when the stay record table is updated, for example. Each of the visit patterns calculated for every location contains data in a plurality of items. The items of the visit pattern contains are exemplified by a distribution of visit frequencies of the plurality of users, a distribution of the stay times of the plurality of users, a distribution of visit time zones of the plurality of users, a distribution of visit days of a week of the plurality of users, and statistic data showing their distributions. As the statistic data, a median and a sample variance are exemplified.

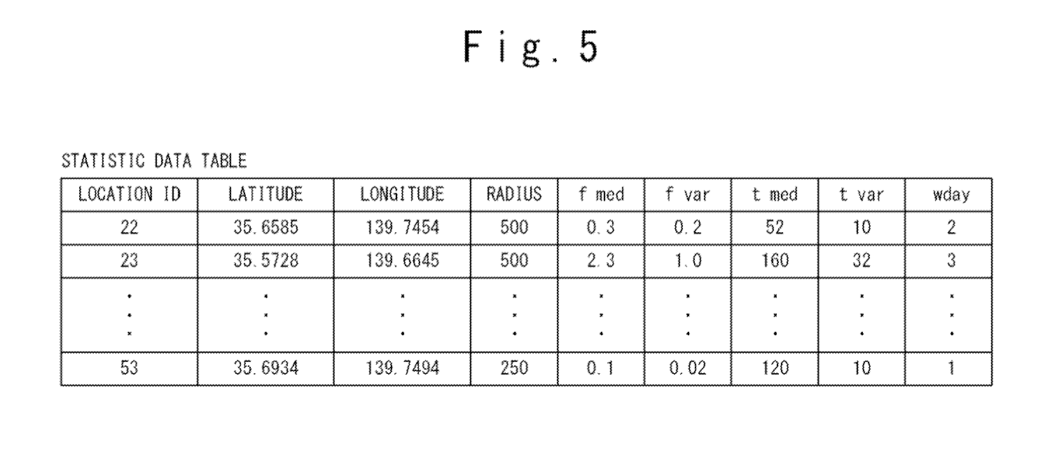

FIG. 5 is a configuration example of a statistic data table. Referring to FIG. 5, the statistic data table contains “location ID” for identifying a location (a stay location); “latitude” for a latitude; “longitude” for a longitude; “radius” for a radius of an area of the stay location; “f med” indicating a median of visit frequencies; “f var” indicating a variance of the visit frequencies; “t med” indicating a median of stay times; “t var” indicating a variance of the stay times; a “wday” indicating a day of the week when the most persons visited. In FIG. 5, from “f med” to “wday” are the items indicate the visit pattern.

The candidate location extracting section 142 acquires recommendation information based on the input of an information provider. The candidate location extracting section 142 refers to the data table in the data storage section 120 at a periodical timing such as once per one day and extracts a location (location ID) related to the recommendation information. When the recommendation information is over a plurality of categories, the candidate location extracting section 142 extracts a plurality of locations related to each category. It should be noted that each of the locations related to the information recommended by the information provider is referred to as a specified location. When extracting the specified location (location ID), the candidate location extracting section 142 refers to the statistic data table of the visit pattern calculating section 141 and extracts a visit pattern of the specified location. At this time, the candidate location extracting section 142 may extract only data of the preset items of the visit pattern. Moreover, the candidate location extracting section 142 extracts a similar location having a visit pattern which is similar to the visit pattern of the specified location. The candidate location extracting section 142 may extract the similar location based on the data of the items of one visit pattern and may extract the similar location based on the data of the items of the plurality of visit patterns.

A method of extracting the similar location by the candidate location extracting section 142 will be described. The candidate location extracting section 142 has a determination value used to extract the similar location and set previously by the information provider. The determination value can be set for each of the items contained in the visit pattern. The candidate location extracting section 142 extracts the visit pattern which has the data of the items of the visit pattern which satisfies the determination value in the same way, from the statistic data table, by using the determination value which the data of an optional item of the visit pattern of the specified location satisfies. For example, it is exemplified that the candidate location extracting section 142 uses “a median of a visit frequencies is in a range of 0.01 to 0.03” as the determination value, and a clustering technique is given as the method of extracting the visit pattern which satisfies the determination value. The candidate location extracting section 142 extracts a location having the extracted visit pattern as the similar location. The candidate location extracting section 142 can extract a plurality of similar locations in relation to one specified location. It should be noted that the specified location and the similar location are referred to as a candidate location. The candidate location extracting section 142 supplies the candidate location and one item of the visit pattern used for the extraction of the similar location to the recommendation level calculating section 150.

The recommendation level calculating section 150 determines priority levels of a plurality of candidate locations every user. The recommendation level calculating section 150 contains a correlation calculating section 151 and a priority level calculating section 152.

The correlation calculating section 151 acquires a plurality of candidate locations and the item of the visit pattern used to extract the similar location from the candidate location extracting section 142. The correlation calculating section 151 refers to the stay record table of the stay record storage section 132 to extract all users who have stayed in at least one of the plurality of candidate locations acquired. Moreover, the correlation calculating section 151 calculates visit patterns to the plurality of candidate locations for each of the extracted users from the stay records of the user. It should be noted that the visit pattern calculated by the correlation calculating section 151 contains the item of the visit pattern used to extract a similar location. The correlation calculating section 151 calculates correlations between the extracted users based on the visit patterns of each user to the plurality of candidate locations.

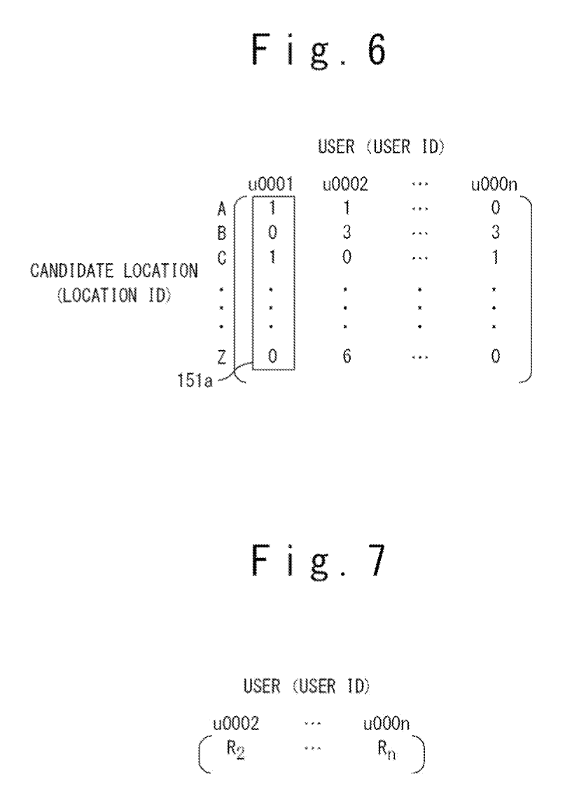

A method of calculating the correlation by the correlation calculating section 151 will be described. FIG. 6 is an example of a matrix in which a plurality of candidate locations, a plurality of users who stayed in the plurality of candidate location, and the number of times of stay of each of the plurality of users every candidate location are arrayed. Referring to FIG. 6, the correlation calculating section 151 acquires the users having “u0001” to “u000n” in the field of “user ID” and the candidate locations having “A” to “Z” in the field of “location ID”. Also, the correlation calculating section 151 acquires that the item of the visit pattern used for the extraction of the plurality of similar locations is the number of times of stay, and calculates the number of times of stay every user from the stay records of the user. The correlation calculating section 151 calculates a correlation coefficient R with the vector of each of other users for every user by paying attention to a vector 151a of the user having “u0001” as “user ID”. At this time, as a method of calculating the correlation coefficient R, a method of calculating Pearson's product-moment correlation coefficient and other methods of calculating correlation coefficient and the similarity may be used. FIG. 7 is a diagram showing the correlation coefficient R between the user having “u0001” and each of the other users when paying attention to the user having “u0001”. The correlation calculating section 151 calculates the correlation coefficient R by paying attention to each user. At this time, the users who stayed in the same candidate location have a high correlation. The correlation calculating section 151 supplies the calculated correlation coefficients R to the priority level calculating section 152.

The priority level calculating section 152 acquires a plurality of correlation coefficients R from the correlation calculating section 151. Each of the plurality of correlation coefficients R shows the correlation between a concerned user and the other users based on the plurality of candidate locations. Therefore, the priority level calculating section 152 calculates a score of the concerned user every candidate location and every other user by using the correlation coefficients R. The priority level calculating section 152 calculates the score every candidate location, considering whether or not the concerned user has stayed in the candidate location (for example, if the concerned user has stayed in a concerned location, the score is made low), whether the correlation between the concerned user and the other user is high (for example, if the correlation is high, the score is made high), and a distance from the current location of the user and so on. As a method of calculating the score by the priority level calculating section 152, the following equation (1) is exemplified.

$$s = α \times ( - log Pu ( l ) ) \times {\sum }_{v ∈ U , v \neq u} {n}_{v} ( l ) \times R ( u , v ) \qquad ( 1 )$$

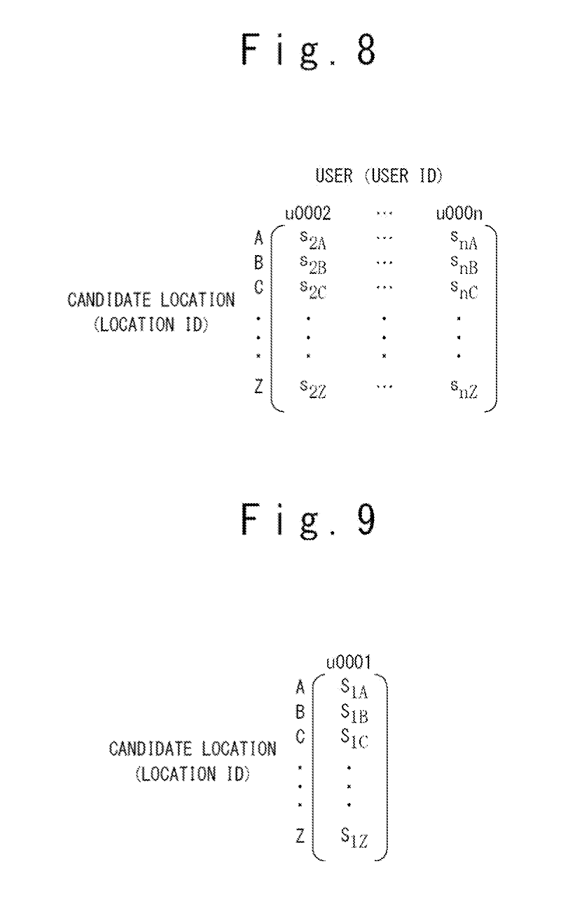

The equation (1) is an equation for calculating a score s in case of a user u, another user v, and a candidate location 1. In the equation (1), • is a constant. Pu(1) is a probability that the user u visits the candidate location 1. nᵥ(1) is the number of times (or a probability) when the user v visits the candidate location 1. R(u,v) is a degree of similarity of the user u and the user v. Referring to the equation (1), the score includes a data amount which is determined based on a rate of the stay of the user u in the candidate location 1, a summation of products of the number of times of visit by the user v, and a correlation coefficient R of the user u and the user v. The score (priority level to be notified) of the user u to the candidate location 1 is calculated from this equation (1). FIG. 8 is a diagram showing an example of the scores of the user having “u0001” every candidate location and every other user.

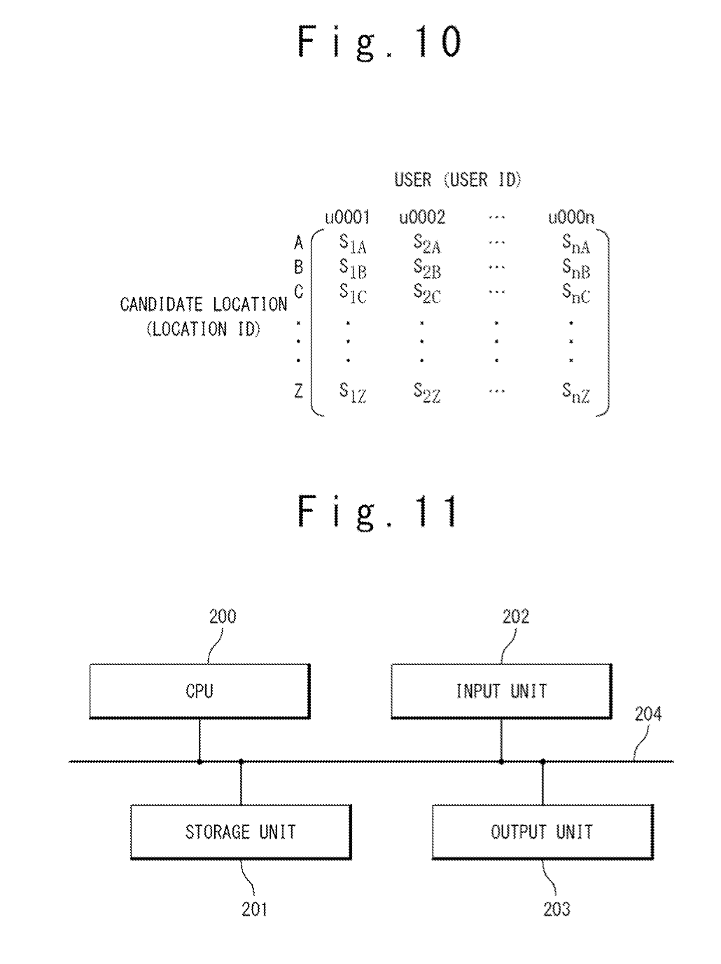

The priority level calculating section 152 calculates the scores of the user having “u0001” every candidate location by arranging the scores shown in FIG. 8 every candidate location. FIG. 9 is a diagram showing the scores of the user having “u0001” every candidate location. It should be noted that the priority level calculating section 152 calculates the scores every candidate location in the same way over all the users. FIG. 10 is a diagram showing the scores calculated every candidate location for all the users.

The priority level calculating section 152 supplies “user ID” used to identify the user of the terminal equipment 10; “location ID” indicative of the candidate location; and the calculated score to the notice data storage section 160.

The notice data storage section 160 stores the “user ID” used to identify the user of the terminal equipment 10; “location ID” indicative of the candidate location; and the calculated score. At this time, the notice data storage section 160 stores data related with “location ID” and extracted from the data table in the data storage section 120 in the same way. Because the score indicates a priority level, the notice data storage section 160 supplies the plurality of candidate locations and the data of the candidate locations to the communication section 100 based on the scores. For example, the notice data storage section 160 determines which data of the electric mail should be transmitted to the user and a display order of the pages of the Web site displayed by the user, based on the scores. The communication section 100 transmits the data to each user based on the scores.

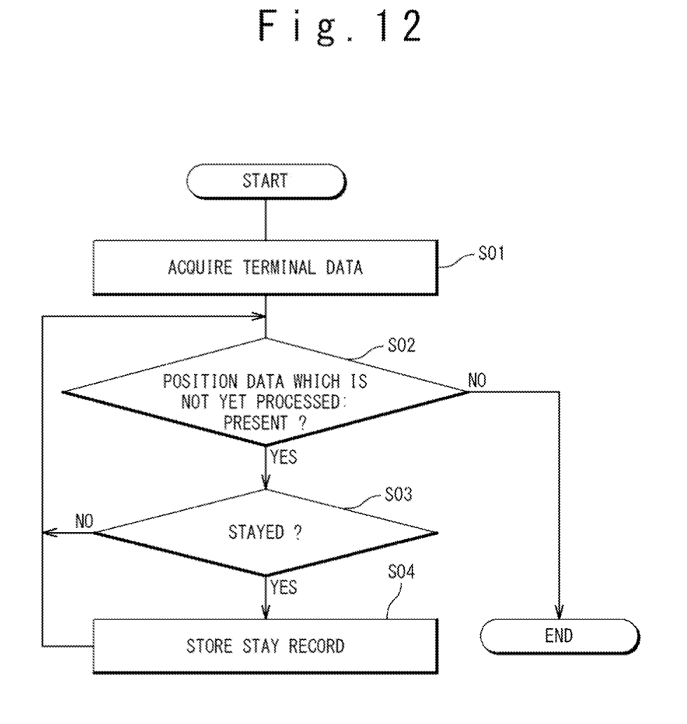

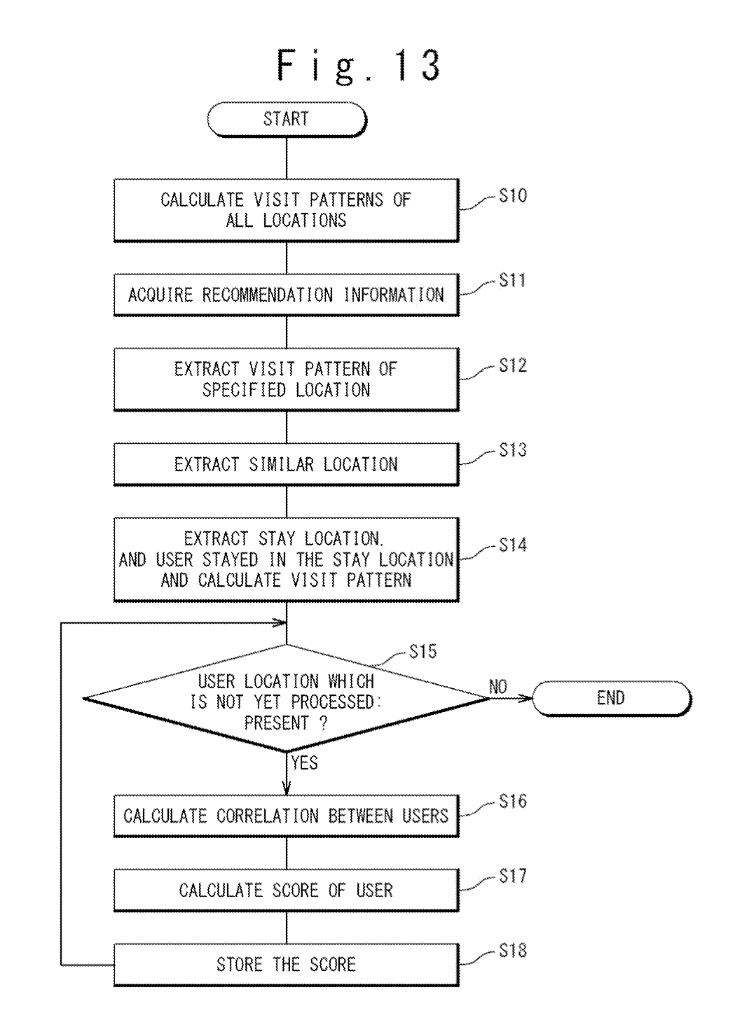

The recommendation information providing system 1 according to the exemplary embodiment of the present invention can be realized by using a computer. FIG. 11 is a block diagram showing a hardware configuration example of the terminal equipment 10 of the recommendation information providing system 1 and the recommendation information providing apparatus 20. Referring to FIG. 11, the terminal equipment 10 and the recommendation information providing apparatus 20 of the present invention is configured of a computer system which is provided with CPU (Central Processing Unit) 200, storage 201, input device 202, output unit 203 and a bus 204 which connects the units in the exemplary embodiment. The CPU 200 executes a program which is for calculation processes and the control processes according to the recommendation information providing system 1 of the present invention and which is stored in the storage unit 201. The storage unit 201 is a unit which stores data, such as a hard disk and a memory. The storage unit 201 stores a program which is read from a computer-readable storage medium, such as a CD-ROM and a DVD, the signal and the program supplied from the input unit 202 and the processing result of the CPU 200. The input unit 202 is a device by which the user can input a command and a signal, such as a mouse, a keyboard, and a microphone. The output unit 203 is a unit such as a display and a speaker, to make the user recognize an output. It should be noted that the present invention is not limited to the hardware configuration example and each section can be realized by hardware and software by them.

FIG. 12 is a flowchart showing the processing operation of storing a stay record (a visit record) in the recommendation information providing system 1 according to the first exemplary embodiment of the present invention. Referring to FIG. 12, the processing operation of storing the stay record according to the first exemplary embodiment of the present invention will be described.

The communication section 100 receives the terminal data from the plurality of terminal equipments 10 through the network 30. The plurality of terminal data are acquired from the communication section 100 by the position data managing section 110. The position data managing section 110 relates the terminal data to the ID for identifying the terminal data and the time recorded in each of the plurality of terminal data and stores in the position data table (Step S01).

The stay record extracting section 131 refers to the position data table to determine whether or not the un-processed position data exists (Step S02).

At a Step S02, when there is no un-processed position data, the stay record extracting section 131 ends the processing.

When there is any un-processed position data at the step S02, the stay record extracting section 131 determines whether or not a user corresponding to “user ID” of the un-processed position data in the position data table has stayed based on the stay condition retained (Step S03). The stay condition is a condition to show that the user has stayed in a given area for a given time period.

At the step S03, when the stay record extracting section 131 determines that the user corresponding to “user ID” of the un-processed position data has not stayed, the control flow returns to the step S02.

At the step S03, when determining that the user corresponding to “user ID” of the un-processed position data has stayed, the stay record extracting section 131 extracts a measurement time and a location where the user has stayed, and supplies them to the stay record storage section 132. The stay record storage section 132 stores the stay time and the location where the user has stayed in the stay record table as a stay record (Step S04).

FIG. 13 is a flow chart showing a processing operation of providing the information which reflects an action pattern and choice of the user in the recommendation information providing system 1 according to the first exemplary embodiment of the present invention. Referring to FIG. 13, the processing operation of providing the information which reflects the action pattern and choice of the user in the first exemplary embodiment of the present invention will be described.

Referring to the stay record table in the stay record storage section 132, the visit pattern calculating section 141 calculates a visit pattern every location (for each of all “location IDs”), and stores the visit patterns to all the locations in the statistic data table (Step S10). It should be noted that each of the visit patterns calculated every location contains a plurality of items. The items contained in the visit pattern are a distribution of the visit frequencies of the plurality of users, a distribution of the stay times by the plurality of users, a distribution of the visit time zones by the plurality of users, a distribution of the visit days of the week by the plurality of users, and a statistic amount showing these distributions are exemplified. As the statistic amount, a median, a sample variance and so on are exemplified.

The candidate location extracting section 142 acquires recommendation information based on an input from the information provider (Step S11).

The candidate location extracting section 142 refers to the data table in the data storage section 120 at periodical timings such as once per a day, and extracts a location (location ID) related to the recommendation information. When the recommendation information is over a plurality of categories, the candidate location extracting section 142 extracts a plurality of locations related to the categories. As described above, the location related to the information which the information provider recommends is referred to as “a specified location”. When extracting the specified location, the candidate location extracting section 142 refers to the stay record table in the visit pattern calculating section 141 and extracts a visit pattern to the specified location (Step S12).

The candidate location extracting section 142 extracts a similar location for the visit pattern which is similar to the visit pattern to the specified location. The candidate location extracting section 142 has a determination value used to extract the similar location and preset by the information provider. The determination value can be set every item contained in the visit pattern. The candidate location extracting section 142 extracts the visit pattern having the item of the visit pattern which satisfies the determination value in the same way, from the statistic data table by using the determination value which an optional item of the visit pattern of the specified location satisfies. The candidate location extracting section 142 extracts the location for an extracted visit pattern as the similar location. The candidate location extracting section 142 can extract a plurality of similar locations in relation to one specified location. It should be noted that the specified location and the similar location are referred to as the candidate location. The candidate location extracting section 142 supplies the plurality of candidate locations and the items of the visit pattern used to extract the similar location to the recommendation level calculating section 150 (Step S13).

The correlation calculating section 151 acquires the plurality of candidate locations and the items of the visit patterns used to extract the similar locations from the candidate location extracting section 142. The correlation calculating section 151 refers to the stay record table in the stay record storage section 132 to extract all the users who stayed in at least one of the acquired candidate locations. Moreover, the correlation calculating section 151 calculates the visit patterns of the plurality of candidate locations every user from the stay records of the users which are contained in the stay record (Step S14). It should be noted that the visit pattern calculated by the correlation calculating section 151 contains the items of the visit pattern used to extract the similar location.

The correlation calculating section 151 determines whether or not any un-processed users for which a correlation coefficient has not yet been calculated, exists in the acquired users (Step S15). If the un-processed user does not exist at the step S15, the correlation calculating section 151 ends processing. The notice data storage section 160 supplies data to the communication section 100 based on the stored score. The communication section 100 transmits the data to each user based on the score.

At the step S15, when the un-processed user exists, the correlation calculating section 151 calculates a correlation coefficient R by using the visit pattern of each user to the plurality of candidate locations in order to calculate whether there is a correlation between the un-processed user and the other user. The correlation calculating section 151 supplies the calculated correlation coefficients R to the priority level calculating section 152 (Step S16).

The priority level calculating section 152 acquires the plurality of correlation coefficients R from the correlation calculating section 151. The priority level calculating section 152 calculates the scores of the concerned user by using plurality of correlation coefficients R every candidate location and every other user. The priority level calculating section 152 calculates the score under the consideration of whether or not the concerned user has stayed in the concerned candidate location, whether or not the correlation between the concerned user and the other user is high, and whether or not a distance from the current location to the user is long. The priority level calculating section 152 supplies “user ID” as the user ID used to identify the user of the terminal equipment 10, “location ID” indicative of the candidate location, and the calculated score to the notice data storage section 160 (Step S17).

The notice data storage section 160 stores “user ID” as the user ID used to identify the user of the terminal equipment 10, “location ID” indicative of the candidate location, and the calculated score. At this time, the notice data storage section 160 relates data related to “location ID” and acquired from the data table in the data storage section 120 and stores it (Step S18). After this, the control flow returns to the step S15.

When there is information in an optional category which the information provider recommends, the recommendation information providing system 1 of the present invention can extract as the candidate location of the recommendation information, a location related to the information and a location having the visit pattern which is similar to the visit pattern to the above location. In other words, the present invention can provide the information in the optional category to be recommended and information in the location related beyond the category. The information to be provided is information of the location visited often by the other user and having the correlation to the visit pattern of the user, and the information is unexpected useful information which reflects the action pattern and choice of the user. For example, a case is taken that information of cafes is provided as a category of the information recommended by the information provider. It is supposed that there are a visit pattern in which many visitors visit a cafe to have a lunch during 12:00 to 13:00 and a visit pattern in which many visitors visit a near park, which is different from the cafe, to have a lunch during 12:00 to 13:00. When information of the cafes is recommended by the information provider, the recommendation information providing apparatus 20 can provide for the user who often uses the cafe during 12:00 to 13:00 through the terminal equipment 10, the information of the near park beyond the category, based on the action pattern of the other user who uses the near park during 12:00 to 13:00. As the information which exceeds the category, when recommending the information of a karaoke box as a category, there would be various cases where information can be provided beyond the category, such as a case where the information of a game center as one category can be provided. In this way, the recommendation information providing system 1 of the present invention can provide the information which reflects the action pattern and choice of the user accurately without being limited to the category of the information recommended by the information provider and the category of the information thought by the user. Especially, the provided information contains the unexpected information which reflects the action pattern and choice of the user but which the information provider and the user himself do not notice. It should be noted that the user of the terminal equipment 10 does not need a special input because the terminal equipment 10 can transmit the position data to the recommendation information providing apparatus 20 automatically and can receive from the recommendation information providing apparatus 20 automatically. That is, the recommendation information providing system 1 of the present invention can provide the unexpected information which reflects the action pattern and choice of the user to the user regardless of the specified input of the user.

### Second Exemplary Embodiment

The second exemplary embodiment of the present invention will be described. The configuration of the second exemplary embodiment of the present invention is the same as that of the first exemplary embodiment. In the second exemplary embodiment of the present invention, because the operation of the visit pattern calculating section 141 is different from that of the first exemplary embodiment, the details of the visit pattern calculating section 141 and the related parts will be described.

Like the first exemplary embodiment, the visit pattern calculating section 141 refers to the stay record table in the stay record storage section 132 to calculate the visit pattern for each of all locations (all “location IDs”) and stores the visit patterns of all the locations in the statistic data table. Here, the visit pattern calculating section 141 stores the visit pattern every location and every user (every “user ID”).

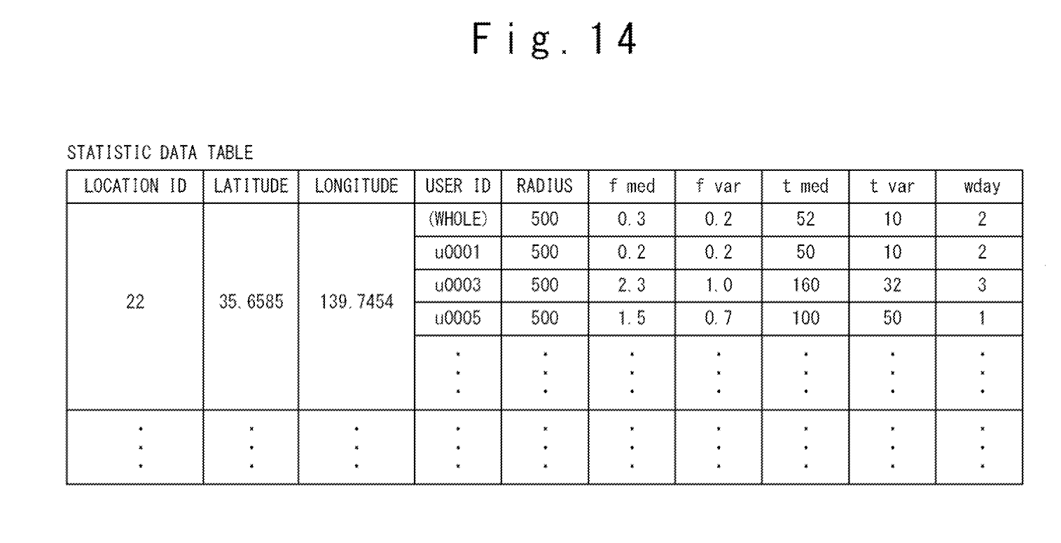

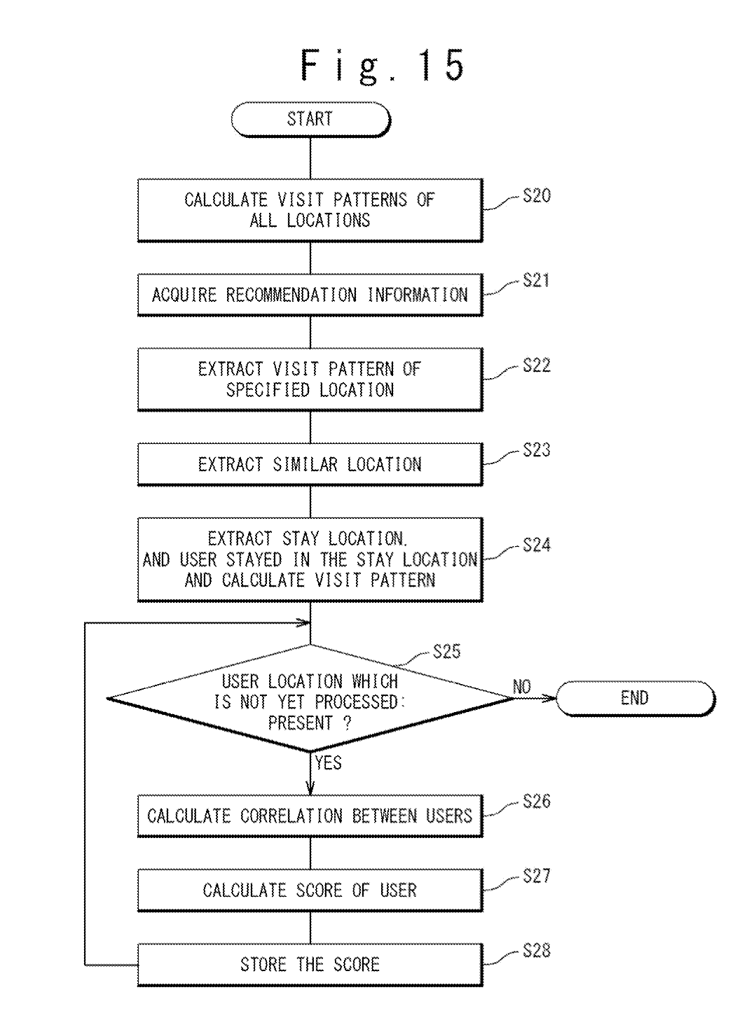

FIG. 14 is a configuration example of the statistic data table in the second exemplary embodiment of the present invention. Referring to FIG. 14, the statistic data table contains “user ID” used to identify the user of the terminal equipment 10, in addition to the storage contents of the statistic data table in the first exemplary embodiment. It should be noted that the record in which the field of “user ID” is blank (shown as a whole in FIG. 14) shows the visit pattern for the whole location.

When acquiring the recommendation information based on the input of the information provider, the candidate location extracting section 142 refers to the data table in the data storage section 120 to extract the location (location ID) related to the recommendation information. It should be noted that the information recommended by the information provider and the location related to the information are referred to as a specified location, like the first exemplary embodiment. When extracting the specified location (location ID), the candidate location extracting section 142 refers to the statistic data table in the visit pattern calculating section 141 to extract the visit pattern to the specified location. Here, the visit pattern to be extracted is the visit pattern which is not identified every user but the visit pattern to the whole location. Moreover, the candidate location extracting section 142 extracts the similar location for the visit pattern which is similar to the visit pattern to the specified location by carrying out a similarity determination every “user ID”. The candidate location extracting section 142 supplies the candidate location to the recommendation level calculating section 150.

FIG. 15 is a flow chart showing the processing operation of providing the information which reflects the action pattern and choice of the user, in the recommendation information providing system 1 according to the second exemplary embodiment of the present invention. It should be noted that because the processing operation of storing the stay record is same as that of the first exemplary embodiment, the description thereof is omitted. Referring to FIG. 15, the processing operation of providing the information which reflects the action pattern and choice of the user in the second exemplary embodiment of the present invention will be described.

The visit pattern calculating section 141 refers to the stay record table in the stay record storage section 132, calculates the visit pattern for each of all the locations every user (“user ID” every) and stores in the statistic data table (Step S20).

The candidate location extracting section 142 acquires the recommendation information based on the input of the information provider (Step S21).

The candidate location extracting section 142 refers to the data table in the data storage section 120 at periodical timings such as once per a day, and extracts the specified location related to the recommendation information. When the recommendation information is over a plurality of categories, the candidate location extracting section 142 extracts a plurality of locations related to the plurality of categories. When extracting the specified location, the candidate location extracting section 142 refers to the stay record table in the visit pattern calculating section 141 to extract the visit pattern to the specified location. Here, the visit pattern to be extracted is the visit pattern which is not identified every user and which is for the whole location (Step S22).

The candidate location extracting section 142 extracts the similar location for the visit pattern which is similar to the visit pattern to the specified location by carrying out a similarity determination every “user ID”. The candidate location extracting section 142 supplies the candidate location to the recommendation level calculating section 150 (Step S23).

The steps S24 to S28 are same as the steps S14 to S18 in the first exemplary embodiment and the description is omitted.

In the recommendation information providing system 1 according to the second exemplary embodiment of the present invention, a selection range of the candidate location extends because the visit patterns to the locations can be grouped every user. In other words, in the present invention, even when the location of the recommendation information and the visit pattern as a whole are different, the visit location of the user with the strong correlation can be selected fully.

### Third Exemplary embodiment

The third exemplary embodiment of the present invention will be described. The configuration of the third exemplary embodiment of the present invention is the same as those of the first and second exemplary embodiments. In the third exemplary embodiment of the present invention, because the operation of the correlation calculating section 151 is different from those of the first and second exemplary embodiments, the details of the correlation calculating section 151 and the related parts will be described.

Like the first and second exemplary embodiments, the correlation calculating section 151 acquires a plurality of candidate locations and the items of the visit patterns used to extract similar locations from the candidate location extracting section 142. The correlation calculating section 151 refers to the stay record table in the stay record storage section 132 to extract all the users who stayed in the candidate locations. Moreover, the correlation calculating section 151 acquires the visit pattern used for the similarity determination by referring to the stay records (the visit records) of all the users. In the third exemplary embodiment, the correlation calculating section 151 calculates a correlation every candidate location based on the visit patterns to the plurality of candidate locations by each user.

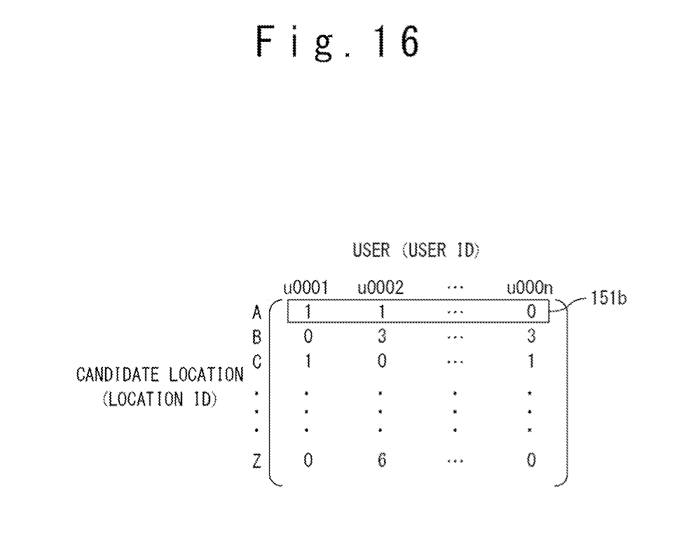

FIG. 16 shows an example of a matrix showing a plurality of candidate locations, all the users of who stayed in the plurality of candidate locations, and the number of times of the stay by each user in the plurality of candidate locations. Like FIG. 6, with respect to FIG. 16, the correlation calculating section 151 acquires users having “u0001” to “u000n” as “user IDs”, and the candidate locations having “A” to “Z” as “location IDs”. Also, the correlation calculating section 151 has acquired the fact that the item of the visit patterns used for the extraction of the plurality of similar locations is the number of times of the stay, and calculates the number of times of stay by each user from the stay record of the user who is contained in the stay record. The correlation calculating section 151 pays attention to a vector 151b having “A” as “location ID” of the candidate location and calculates the correlation coefficient R with a vector for the other location every other location. The correlation calculating section 151 supplies the calculated correlation coefficients R to the priority level calculating section 152.

The priority level calculating section 152 acquires the plurality of correlation coefficients R from the correlation calculating section 151. The correlation coefficient R shows the correlation between the concerned candidate location and the other candidate location based on the user. The priority level calculating section 152 calculates a score of the user every candidate location and every other user by using each correlation coefficient R. The priority level calculating section 152 calculates the score every user under the consideration of whether or not a correlation between a candidate location and a candidate location is high (for example, when the correlation is high, the score becomes high), and whether or not the concerned user has stayed in the concerned candidate location (for example, if the concerned user stayed in the concerned location, the score becomes low). The priority level calculating section 152 can calculate the score by using an equation like the equation (1) in the first exemplary embodiment. The priority level calculating section 152 supplies “user ID” used to identify the user of the terminal equipment 10, “location ID” indicative of the candidate location, and the calculated score to the notice data storage section 160.

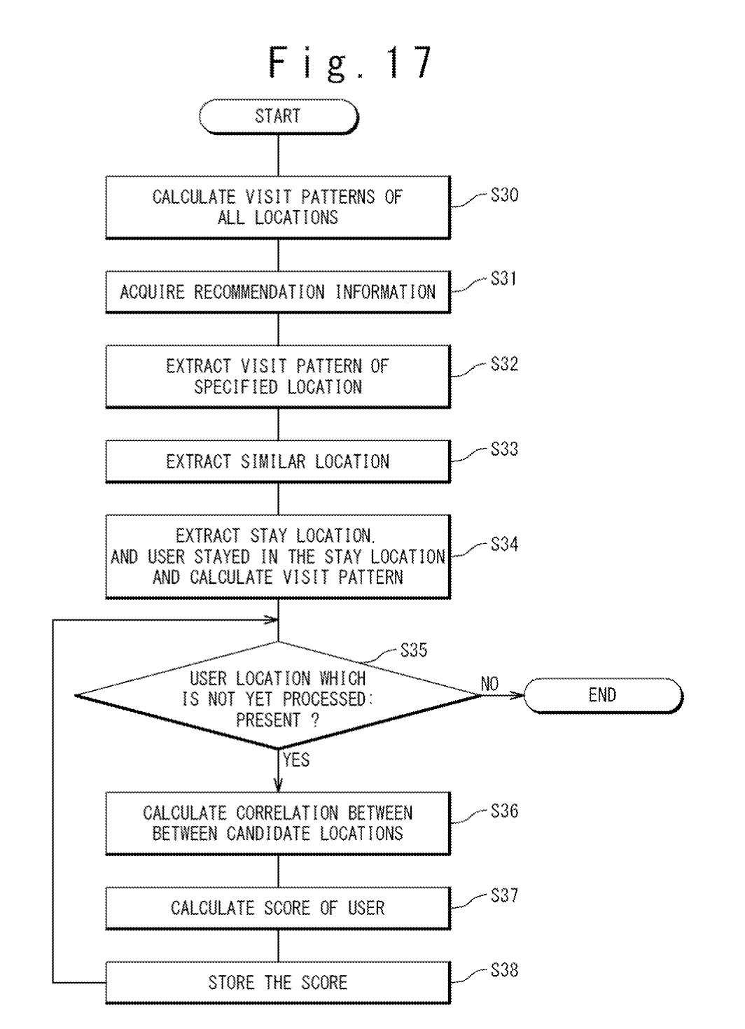

FIG. 17 is a flow chart showing the processing operation of providing the information which reflects the action pattern and choice of the user in the recommendation information providing system 1 according to the third exemplary embodiment of the present invention. It should be noted that because the processing operation of storing a stay record is same as that of the first exemplary embodiment of the present invention, the description is omitted. Referring to FIG. 17, the processing operation of providing the information which reflects the action pattern and choice of the user in the third exemplary embodiment of the present invention will be described. It should be noted that the operation at the steps S30 to S34 is same as the operation at the steps S10 to S14, and the description is omitted.

The correlation calculating section 151 determines whether or not an un-processed candidate location for which the correlation coefficient has not been calculated is present in the acquired candidate locations (Step S35).

At the step S35, if the un-processed candidate location does not exist, the correlation calculating section 151 ends processing. The notice data storage section 160 supplies information to the communication section 100 based on the stored scores. The communication section 100 transmits the information to each user based on the score.

At the step S35, when the un-processed candidate location exists, the correlation calculating section 151 calculates a correlation coefficient R by using the visit patterns of each user to the plurality of candidate locations, in order to calculate a correlation between the un-processed candidate location and another candidate location. The correlation calculating section 151 supplies the calculated correlation coefficients R to the priority level calculating section 152 (Step S36).

The priority level calculating section 152 acquires the plurality of correlation coefficients R from the correlation calculating section 151. The priority level calculating section 152 calculates the score of the concerned user by using each correlation coefficient R every candidate location and every other user. The priority level calculating section 152 calculates the score every user under the consideration of whether the correlation between the candidate location and the candidate location is high (for example, when the correlation is high, the score becomes high), whether the concerned user has stayed in the concerned candidate location (for example, if the concerned user stayed in the location, the score becomes low) and so on. The priority level calculating section 152 supplies “user ID” used to identify the user of the terminal equipment 10, “location ID” indicative of the candidate location, and the calculated scores to the notice data storage section 160 (Step S37).

The notice data storage section 160 stores “user ID” used to identify the user of the terminal equipment 10, “location ID” indicative of the candidate location and the calculated scores. At this time, the notice data storage section 160 relates the data related to “location ID” acquired from the data table and stores in the data storage section 120 (Step S38). After this, the control flow returns to the step S35.

The recommendation information providing system 1 according to the third exemplary embodiment of the present invention can provide the recommendation information based on the correlation in which attention is paid to the location. Especially, in the third exemplary embodiment of the present invention, when the numbers of candidate locations is few, the correlation can be calculated with a little amount of calculation. It should be noted that the exemplary embodiments of the present invention may be combined in a range where there is not contradiction.

Referring to the above exemplary embodiments, the present invention has been described. However, the present invention is not limited to the above exemplary embodiments. Various modifications to the configuration and the details of the present invention can be made in a scope of the present invention.

This patent application claims a priority on convention based on Japanese Patent Application No. JP 2009-133036 filed on Jun. 2, 2009. The disclosure thereof is incorporated herein by reference.

What is claimed is:

1. A recommendation information providing apparatus comprising:
a stay record managing section configured to store a stay record as a record when each of a plurality of users stayed in each of a plurality of locations;
a visit pattern calculating section configured to calculate a first visit pattern showing statistic data of said stay records for each of said plurality of locations;
a candidate location extracting section configured to extract a second visit pattern to a specified location related to recommendation information from a plurality of said first visit patterns, extract a third visit pattern which meets a determination value met by said second visit pattern from said plurality of first visit patterns, and extract a similar location having said third visit pattern from said plurality of locations; and
a recommendation level calculating section configured to extract from said stay records, a first user and a second user of said plurality of users who stayed in at least one of said specified location and said similar location, calculate a fourth visit pattern of said first user to said specified location and said similar location from ones of said stay records related to said first user, calculate a fifth visit pattern of said second user to said specified location and said similar location from ones of said stay records related to said second user, and calculate a first priority level of said specified location and said similar location to be notified to said first user and a second priority level of said specified location and said similar location to be notified to said second user based on said fourth visit pattern and said fifth visit pattern.

2. The recommendation information providing apparatus according to claim 1, wherein said recommendation level calculating section comprises:
a priority level calculating section configured to calculate a priority level of said specified location or said similar location in said stay record related to said first user low, in the calculation of said first priority level, and calculate a priority level of said specified location or said similar, location in said stay record related to said second user low in the calculation of said second priority level.

3. The recommendation information providing apparatus according to claim 2, wherein said recommendation level calculating section further comprises:
a correlation calculating section configured to calculate a correlation between said first user and said second user based on said fourth visit pattern and said fifth visit pattern, and
wherein said priority level calculating section calculates priority levels of said specified location and said similar location high, when the correlation between said first user and said second user is high.

4. The recommendation information providing apparatus according to claim 2, wherein said recommendation level calculating section further comprises:
a correlation calculating section configured to calculate a correlation between said specified location and said similar location based on said fourth visit pattern and said fifth visit pattern, and
wherein said priority level calculating section calculates priority levels of said specified location and said similar location high, when the correlation between said specified location and said similar location is high.

5. The recommendation information providing apparatus according to claim 1, wherein said first visit pattern contains a sixth visit pattern showing the statistic data of the stay records for each of said plurality of users, and
wherein said candidate location extracting section extracts said third visit pattern which meets said determination value met by said second visit pattern, from a plurality of said sixth visit patterns.

6. The recommendation information providing apparatus according to claim 1, further comprising:
a position data managing section configured to store a set of position data of each of said plurality of users and measurement time related with said position data,
wherein said stay record managing section determines that each of said plurality of users stayed in a given area for a given time, based on said position data and said measurement time, and stores a set of each of said plurality of users and each of said plurality of locations where each of said plurality of users stayed, as said stay record.

7. A recommendation information providing method comprising:
storing a stay record as a record when each of a plurality of users stayed in each of a plurality of locations;
calculating a first visit pattern showing statistic data of said stay records for each of said plurality of locations;
extracting a second visit pattern to a specified location related to recommendation information from a plurality of said first visit patterns;
extracting a third visit pattern which meets a determination value met by said second visit pattern, from said plurality of first visit patterns;
extracting a similar location having said third visit pattern from said plurality of locations;
extracting a first user and a second user of said plurality of users who stayed in at least one of said specified location and said similar location from said stay records;
calculating a fourth visit pattern of said first user to said specified location and said similar location from ones of said stay records related to said first user;
calculating a fifth visit pattern of said second user to said specified location and said similar location from ones of said stay records related to said second user;
calculating a first priority level of said specified location and said similar location to be notified to said first user based on said fourth visit pattern and said fifth visit pattern; and
calculating a second priority level of said specified location and said similar location to be notified to said second user based on said fourth visit pattern and said fifth visit pattern.

8. The recommendation information service method according to claim 7, wherein said calculating a first priority level comprises:
calculating a priority level of said specified location or said similar location in said stay records related to said first user low, and
wherein said calculating a second priority level comprises:
calculating a priority level of said specified location or said similar location in said stay records related to said second user low.

9. The recommendation information service method according to claim 8, further comprising:
calculating a correlation between said first user and said second user based on said fourth visit pattern and said fifth visit pattern,
wherein said calculating a first priority level comprises:
calculating the priority levels of said specified location and said similar location high, when the correlation between said first user and said second user is high, and
wherein said calculating a second priority level comprises:
calculating the priority levels of said specified location and said similar location, when the correlation between said first user and said second user is high.

10. The recommendation information service method according to claim 8, further comprising
calculating a correlation between said specified location and said similar location based on said fourth visit pattern and said fifth visit pattern,
wherein said calculating a first priority level comprises:
calculating the priority levels of said specified location and said similar location high, when the correlation between said specified location and said similar location is high, and
wherein said calculating a second priority level comprises:
calculating the priority levels of said specified location and said similar location, when the correlation between said specified location and said similar location is high.

11. The recommendation information service method according to claim 7, wherein said first visit pattern contains a sixth visit pattern showing the statistic data of said stay records related to each of said plurality of users, and
wherein said extracting a third visit pattern comprises:
extracting said third visit pattern which meets said determination value met by said second visit pattern, from a plurality of said sixth visit patterns.

12. The recommendation information service method according to claim 7, further comprising:
storing a set of position data of each of said plurality of users and measurement time related with said position data,
wherein said storing a stay record comprises:
determining that each of said plurality of users stayed in a given area for a given time, based on said position data and said measurement time; and
storing a set of each of said plurality of users and each of said plurality of locations where each of said plurality of users stayed, as said stay record based on the determining result.

13. A computer-readable non-transitory recording medium which stores a computer-executable program code to attain a recommendation information service method which comprises:
storing a stay record as a record when each of a plurality of users stayed in each of a plurality of locations;
calculating a first visit pattern showing statistic data of said stay records for each of said plurality of locations;
extracting a second visit pattern to a specified location related to recommendation information from a plurality of said first visit patterns;
extracting a third visit pattern which meets a determination value met by said second visit pattern, from said plurality of first visit patterns:
extracting a similar location having said third visit pattern from said plurality of locations;
extracting a first user and a second user of said plurality of users who stayed in at least one of said specified location and said similar location from said stay records;
calculating a fourth visit pattern of said first user to said specified location and said similar location from ones of said stay records related to said first user;
calculating a fifth visit pattern of said second user to said specified location and said similar location from ones of said stay records related to said second user;
calculating a first priority level of said specified location and said similar location to be notified to said first user based on said fourth visit pattern and said fifth visit pattern; and
calculating a second priority level of said specified location and said similar location to be notified to said second user based on said fourth visit pattern and said fifth visit pattern.

14. A recommendation information providing system comprising:
a terminal equipment configured to transmit first position data of a first user; and
a recommendation information providing apparatus configured to receive said first position data,
wherein said recommendation information providing apparatus comprises:
a position data managing section configured to store a set of second position data of each of said plurality of users, which includes said first user, and measurement time related with said second position data, said second position data including said first position data;
a stay record managing section configured to determine that each of said plurality of users stayed in a given area for a given time, based on said second position data and said measurement time, and stores a set of each of said plurality of users and each of said plurality of locations where each of said plurality of users stayed, as said stay record,
a visit pattern calculating section configured to calculate a first visit pattern showing statistic data of said stay records for each of said plurality of locations;
a candidate location extracting section configured to extract a second visit pattern to a specified location related to recommendation information from a plurality of said first visit patterns, extract a third visit pattern which meets a determination value met by said second visit pattern from said plurality of first visit patterns, and extract a similar location having said third visit pattern from said plurality of locations; and
a recommendation level calculating section configured to extract from said stay records, a first user and a second user of said plurality of users who stayed in at least one of said specified location and said similar location, calculate a fourth visit pattern of said first user to said specified location and said similar location from one stay record of said first user which is contained in said stay records, calculate a fifth visit pattern of said second user to said specified location and said similar location from one stay record of said second user which is contained in said stay records, and calculate a first priority level of said specified location and said similar location to be notified to said first user and a second priority level of said specified location and said similar location to be notified to said second user based on said fourth visit pattern and said fifth visit pattern.
